(19) United States
(12) Patent Application Publication
(10) Pub. No.: US 2007/0091840 A1
(43) Pub. Date: Apr. 26, 2007

(54) Decoupled MAC index for enhanced EVDO systems

(75) Inventors: Purva R. Rajkotia, Plano, TX (US); Sanjaykumar Kodali, Plano, TX (US); Chanakya Bandyopadhyay, Richardson, TX (US); Rajasimman Vijayasimman, Richardson, TX (US)

Correspondence Address: DOCKET CLERK, P.O. DRAWER 800889, DALLAS, TX, 75380, US

(73) Assignee: SAMSUNG ELECTRONICS Co., LTD., Suwon-city (KR)

(21) Appl. No.: 11/418,753

(22) Filed: May 5, 2006

Related U.S. Application Data
(60) Provisional application No. 60/728,524, filed on Oct. 20, 2005.

(51) Int. Cl. H04Q 7/00

(52) U.S. Cl. 370/329

(57) ABSTRACT

A system for providing optimized utilization and efficiency of traffic channels in Evolution Data-Only (EVDO) based communications systems is disclosed. A given communication channel has a unique first parameter associated with it. A plurality of second parameters, each associated with a specific traffic function, is provided. An individual traffic element is assigned a first and second parameter, indicating its channel allocation and traffic function, respectively. Other traffic elements are also assigned a first and second parameter, and may be allowed concurrent access to a given communication channel if their second parameter is different from the second parameter of the individual traffic element. Access to communication channels may also be prioritized based upon a traffic element's assigned second parameter.

### CROSS-REFERENCE TO RELATED APPLICATION AND CLAIM OF PRIORITY

The present application is related to U.S. Provisional Patent No. 60/728,524, filed Oct. 20, 2005, entitled “Decoupling Of MAC Index For Evolved DO Systems”. U.S. Provisional Patent No. 60/728,524 is assigned to the assignee of the present application and is hereby incorporated by reference into the present disclosure as if fully set forth herein. The present application hereby claims priority under 35 U.S.C. §119(e) to U.S. Provisional Patent No. 60/728,524.

### TECHNICAL FIELD OF THE INVENTION

The present invention related generally to wireless communication devices and, more specifically, to methods for optimizing transmission efficiency and capacity in an Enhanced Evolution-Data Only (EEVDO)-based wireless communication system.

### BACKGROUND OF THE INVENTION

Evolution-Data Only, often abbreviated as EV-DO, 1xEV-DO, or EVDO is a wireless broadband data standard that has been adopted by a number of CDMA service providers throughout the world as part of the CDMA2000 family of standards. Initially, EVDO was developed in response to needs for high data rate transmissions in wireless systems. As provider and user needs and demands have increased over time, revisions of EVDO have proposed various enhancements and optimizations. The most recent of these proposed revisions has commonly been referred to as enhanced EVDO (EEVDO).

Under current and proposed EVDO and EEVDO standards, there are 64 MAC (Medium Access Control) Indices available for use by the forward channel. Each MAC index corresponds to a different 64-ary Walsh code. Transmissions on the forward traffic channel are time division multiplexed. At any given time, a particular channel is either being transmitted or not. If it is being transmitted, then it is addressed to a single user (or mobile station). When transmitting, the access network uses the MAC index to identify the target access terminal.

A preamble sequence is transmitted with each forward traffic channel or control channel packet. This preamble is covered by a 32-chip bi-orthogonal sequence; which are specified in terms of 32-ary Walsh functions that correspond to specific MAC indices. The preamble either identifies the packet as a broadcast control channel packet (i.e., MAC index 2 or 3) or identifies the target access terminal for the forward traffic channel (i.e., MAC indices 5 to 63). MAC indices 0 and 1 are reserved. MAC index 4 is used for the Reverse Activity (RA) channel—which transmits the Reverse Activity Bit (RAB) stream over the MAC index 4 channel.

Thus, conventionally, there are at most 5 MAC indexes, and corresponding channels, dedicated to control traffic and at most 59 MAC indexes, and corresponding channels, dedicated to user traffic. In situations where there may be greater demand for control traffic and unused user traffic channels, or vice versa, system inefficiencies result as unused channels go unutilized while other channels are over capacity. In addition, capabilities for simultaneous forward channel and reverse channel traffic may be limited, due to full assignment of a single channel (i.e., MAC index) to a single user—who may only be transmitting on either the forward or reverse channel.

As a result, there is a need for a system that decouples the channel allocation function of MAC indices, and their corresponding Walsh codes, from their traffic identification function, providing a flexible and efficient utilization of all available traffic channels and improved user capacity.

### SUMMARY OF THE INVENTION

A versatile scheme provides an effective de-coupling of MAC channel and traffic preamble Walsh codes in an EEVDO system—providing optimal transmission efficiency and capacity without having a negative impact on the sensitivity and throughput of the system.

Specifically, the system of the present disclosure defines an allocation or prioritization parameter transmitted during traffic channel allocation (TCA). This allocation parameter indicates one of several modes of allocation, where different priorities of Walsh code assignment to MAC channel or traffic preamble are utilized. Depending upon which mode is selected or signalled, MAC channel or traffic preamble may have priority access to channel allocation, up to the maximum available channels (e.g., 64). Furthermore, the system provides user sharing of a given MAC index by users having the same MAC index Walsh code, but different function identification Walsh codes (e.g., one forward MAC channel, one forward traffic channel).

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the terms “element”, “construct” or “component” may mean any device, system or part thereof that performs a processing, control or communication operation; and such a device may be implemented in hardware, firmware or software, or some combination of at least two of the same. It should be noted that the functionality associated with any particular construct or component may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an exemplary wireless network in which the channel allocation and traffic identification functions of a given set of MAC index Walsh codes are de-coupled according to the principles of the present disclosure;

FIG. 2 depicts one embodiment of a traffic allocation message segment according to certain aspects of the present disclosure; and

FIG. 3 depicts one embodiment of a traffic channel allocation operation according to certain aspects of the present disclosure.

### DETAILED DESCRIPTION OF THE INVENTION

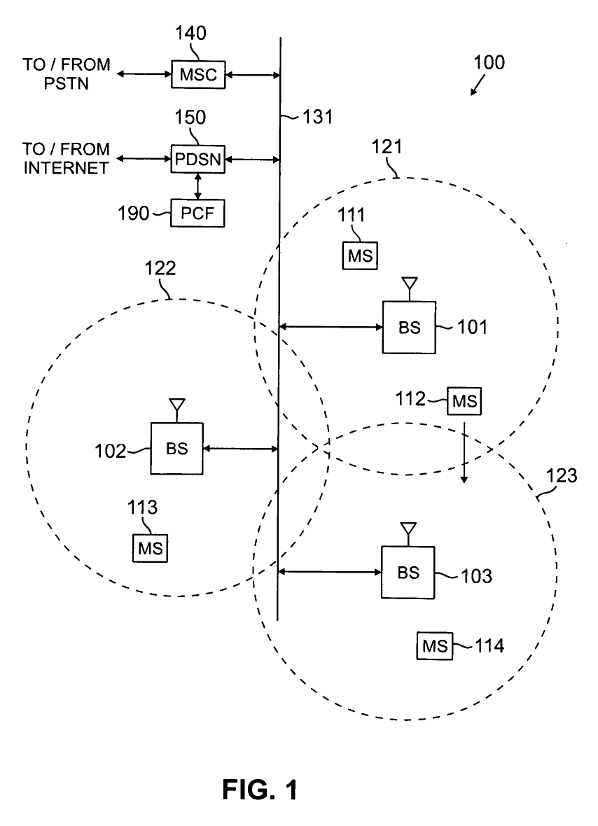

FIGS. 1-3, discussed below, and the various embodiments used to describe the principles of the present disclosure in this patent document are by way of illustration only, and should not be construed in any way to limit the scope of the disclosure. Hereinafter, certain aspects of the present disclosure are described in relation to illustrative embodiments and operations of wireless communications systems and networks. Those skilled in the art, however, will understand that the principles and teachings of the present disclosure may be implemented in a variety of suitably arranged wireless communications devices or systems—regardless of the specific form factor, location, or functionality of that device or system.

The following discloses a scheme whereby the channel allocation and traffic identification functions of a given set of MAC index Walsh codes are de-coupled. A division or replication of the set of Walsh codes (or Walsh covers) associated with a given set of MAC indices provides separate indicators for channel assignment and traffic function. Traffic channel allocation signaling is supplemented in a manner that provides prioritization based upon traffic function.

For purposes of explanation and illustration, the methods and operations of the present disclosure are described hereafter in reference to various operational aspects of EVDO and EEVDO systems, as defined by applicable CDMA2000 standards and proposals—i.e., 3GPP2 1xEV-DO through 1xEV-DO Rev. B. Those standards and proposals are hereby incorporated by reference.

FIG. 1 illustrates exemplary wireless network 100, in which the channel allocation and traffic identification functions of a given set of MAC index Walsh codes are de-coupled according to the principles of the present disclosure. Wireless access network 100 comprises a plurality of cells (or cell sites) 121-123, each containing one of the base stations, BS 101, BS 102, or BS 103. Base stations 101-103 communicate with a plurality of mobile stations (MS) 111-114, also referred to as access terminals, over code division multiple access (CDMA) channels according to, for example, the IS-2000 standard (i.e., CDMA2000). In an advantageous embodiment of the present disclosure, mobile stations 111-114 are capable of receiving data traffic and/or voice traffic on two or more CDMA channels simultaneously. Mobile stations 111-114 may be any suitable wireless devices (e.g., conventional cell phones, PCS handsets, personal digital assistant (PDA) handsets, portable computers, telemetry devices) that are capable of communicating with base stations 101-103 via wireless links.

The present disclosure is not limited to mobile devices. The present disclosure also encompasses other types of wireless access terminals, including fixed wireless terminals. For the sake of simplicity, only mobile stations are shown and discussed hereafter. However, it should be understood that the use of the term “mobile station” in the claims and in the description below is intended to encompass both truly mobile devices (e.g., cell phones, wireless laptops) and stationary wireless terminals (e.g., a machine monitor with wireless capability).

Dotted lines show the approximate boundaries of cells (or cell sites) 121-123 in which base stations 101-103 are located. It is noted that the terms “cells” and “cell sites” may be used interchangeably in common practice. For simplicity, the term “cell” will be used hereafter. The cells are shown approximately circular for the purposes of illustration and explanation only. It should be clearly understood that the cells may have other irregular shapes, depending on the cell configuration selected and variations in the radio environment associated with natural and man-made obstructions.

As is well known in the art, each of cells 121-123 is comprised of a plurality of sectors, where a directional antenna coupled to the base station illuminates each sector. The embodiment of FIG. 1 illustrates the base station in the center of the cell. Alternate embodiments may position the directional antennas in corners of the sectors. The system of the present disclosure is not limited to any particular cell configuration.

In one embodiment of the present disclosure, each of BS 101, BS 102 and BS 103 comprises a base station controller (BSC) and one or more base transceiver subsystem(s) (BTS). Base station controllers and base transceiver subsystems are well known to those skilled in the art. A base station controller is a device that manages wireless communications resources, including the base transceiver subsystems, for specified cells within a wireless communications network. A base transceiver subsystem comprises the RF transceivers, antennas, and other electrical equipment located in each cell. This equipment may include air conditioning units, heating units, electrical supplies, telephone line interfaces and RF transmitters and RF receivers. For the purpose of simplicity and clarity in explaining the operation of the present disclosure, the base transceiver subsystems in each of cells 121, 122 and 123 and the base station controller associated with each base transceiver subsystem are collectively represented by BS 101, BS 102 and BS 103, respectively.

BS 101, BS 102 and BS 103 transfer voice and data signals between each other and the public switched telephone network (PSTN) (not shown) via communication line 131 and mobile switching center (MSC) 140. BS 101, BS 102 and BS 103 also transfer data signals, such as packet data, with the Internet (not shown) via communication line 131 and packet data server node (PDSN) 150. Packet control function (PCF) unit 190 controls the flow of data packets between base stations 101-103 and PDSN 150. PCF unit 190 may be implemented as part of PDSN 150, as part of MSC 140, or as a stand-alone device that communicates with PDSN 150, as shown in FIG. 1. Line 131 also provides the connection path for control signals transmitted between MSC 140 and BS 101, BS 102 and BS 103 that establish connections for voice and data circuits between MSC 140 and BS 101, BS 102 and BS 103.

Communication line 131 may be any suitable connection means, including a T1 line, a T3 line, a fiber optic link, a network packet data backbone connection, or any other type of data connection. Alternatively, communication line 131 may be replaced by a wireless backhaul system, such as microwave transceivers. Communication line 131 links each vocoder in the BSC with switch elements in MSC 140. The connections on communication line 131 may transmit analog voice signals or digital voice signals in pulse code modulated (PCM) format, Internet Protocol (IP) format, asynchronous transfer mode (ATM) format, or the like.

MSC 140 is a switching device that provides services and coordination between the mobile stations in a wireless network and external networks, such as the PSTN or Internet. MSC 140 is well known to those skilled in the art. In some embodiments, communication line 131 may be several different data links where each data link couples one of BS 101, BS 102, or BS 103 to MSC 140.

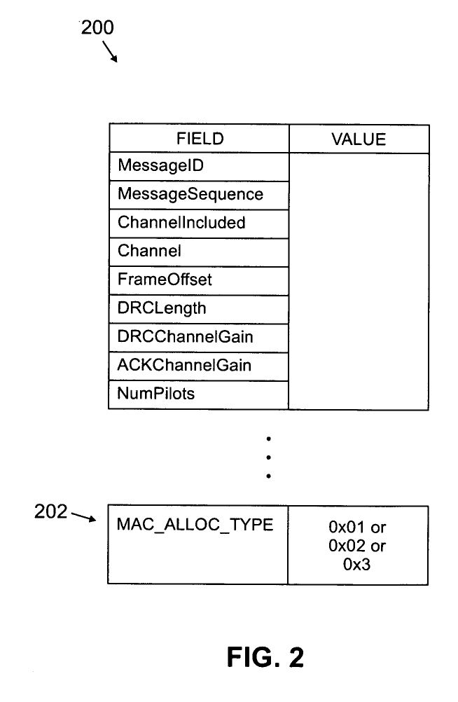

In a first aspect of the present system, illustratively depicted now with reference to FIG. 2, a portion of a traffic channel assignment message (TCM) 200 is shown supplemented with an allocation or prioritization field or parameter 202. Traffic channel assignment messages similar to TCM 200 are transmitted in forward channels from base stations 101-103 to mobile stations 111-114. Parameter 202 may define a plurality of allocation modes, each having different priority of Walsh code or cover (hereinafter used interchangeably) assignment to MAC channel (i.e., control traffic) or traffic preamble (i.e., user traffic).

In the embodiment illustrated, for example, three such modes—0x01, 0x02 or 0x3—may be provided. In this embodiment, the 0x3 mode may be provided for purposes of backwards compatibility with previous EVDO systems, corresponding to MAC allocation fixed to 5 MAC channel and 59 traffic preamble Walsh covers. The 0x02 mode may be provided to correspond to a traffic preamble priority state, where allocation of all Walsh covers gives priority to traffic preambles. To the extent that not all Walsh covers are utilized for traffic preambles, the remainder may then be utilized for MAC channels. The 0x01 mode may be provided to correspond to a MAC channel priority state, where allocation of all Walsh covers gives priority to MAC channels. To the extent that not all Walsh covers are utilized for MAC channels, the remainder may then be utilized for traffic preambles.

In alternative embodiments, the number and definition of the modes provided may be altered substantially to accommodate the requirements or needs of a particular system. For example, in a system where backwards compatibility is not a concern, only the 0x01 and 0x02 modes may be provided. In a system where multiple prioritization schemes need to be accommodated, then any number of modes may be provided. All such variations and combinations thereof are hereby comprehended.

Thus, during the connection negotiation process between a wireless access terminal and an access network, the TCM is supplemented to provide a preferential utilization of available channels as directed by an operator or provider. Where there are mismatches between demand, capacity and utilization, channel assignment may be reallocated to optimize system efficiency.

In another aspect of the present system, the one-to-one correspondence of MAC index Walsh covers and channel allocations is removed—providing a bifurcated indication of channel assignment and traffic type for any given transmission. A first set of Walsh covers (e.g., 32-bit) are provided for indicating MAC index channel allocation. A second set of Walsh covers are provided for indicating the type or function of any particular traffic element on a given channel (i.e., control or user traffic). For any given transmission or traffic element, two Walsh covers are assigned—and may be combined or processed independently. Thereby, within a single MAC index channel, independent transmissions may be provided concurrently. For example, in certain embodiments, a single MAC index may be utilized to provide forward channel and reverse channel traffic.

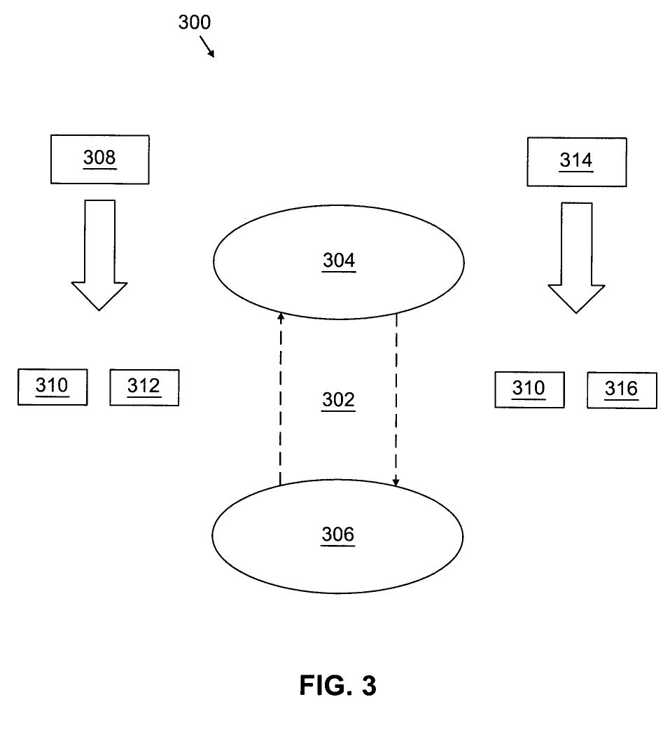

This is depicted now with reference to FIG. 3, which provides a schematic illustration of a shared index operation 300 in accordance with the present disclosure. In FIG. 3, user 308 represents one of mobile stations 111-114 and user 314 also represents one of mobile stations 111-114. A traffic channel 302 is established between a first carrier 304 and a second carrier 306, and is associated with a given MAC Index X. As a first user 308 establishes its traffic channel allocation, two Walsh covers 310 and 312 are associated with user 308. Walsh cover 310 is associated with channel 302 (i.e., index X), and indicates which traffic channel is to be utilized. Walsh cover 312, however, provides a differentiation and identification of the type of traffic for which user 308 needs channel 302.

For example, user 308 may require channel 302 for MAC channel, not traffic preamble, and may only require reverse transmission. As such, channel 302 may be concurrently utilized by a second user 314, where that user's needs are differentiated from user 308. For example, if user 314 requires channel 302 for traffic preamble in forward transmission, then channel 302 may be successfully shared by users 308 and 314. Traffic for user 314 thus has two Walsh covers 310 and 316 associated with it as it establishes its traffic channel allocation. Walsh cover 310 is the same for both users 308 and 314, since it is in fixed association with channel 302. Walsh cover 316, however, indicates traffic preamble in forward transmission—differentiating the nature of traffic between users 308 and 314. As such, concurrent independent transmissions are provided within single MAC index channel 302.

Depending upon the number of differentiating parameters (i.e., Walsh covers) assigned, a plurality of users may concurrently share a single index channel (X). This increases the capacity and efficiency of Walsh code usage, and system performance, without degrading system sensitivity and throughput. Additionally, the prioritization of traffic allocation further optimizes system throughput by minimizing or eliminating capacity shortages. Thus, for a given carrier, the number of simultaneous users can be extended well beyond current channel limitations (e.g., 59).

It should be apparent to those of skill in the art that the present disclosure is not limited solely to a particular type of wireless communications device. The present disclosure encompasses a wide variety of fixed and mobile wireless devices (e.g., mobile phones, laptop computers, PDAs)—especially as the functions of such devices converge and evolve. It should therefore be understood that the use of the term “wireless communications device”, “wireless device” or “wireless communications system” in the claims and in the description is intended to encompass a wide range of wireless data and communications components.

Although certain aspects of the present disclosure have been described in relations to specific systems, standards and structures, it should be easily appreciated by one of skill in the art that the system of the present disclosure provides and comprehends a wide array of variations and combinations easily adapted to a number of wireless communications system. As described herein, the relative arrangement and operation of necessary functions may be provided in any manner suitable for a particular application. All such variations and modifications are hereby comprehended. It should also be appreciated that the constituent members or components of this system may be produced or provided using any suitable hardware, firmware, software, or combination(s) thereof.

The embodiments and examples set forth herein are therefore presented to best explain the present disclosure and its practical application, and to thereby enable those skilled in the art to make and utilize the system of the present disclosure. The description as set forth herein is therefore not intended to be exhaustive or to limit any invention to a precise form disclosed. As stated throughout, many modifications and variations are possible in light of the above teaching without departing from the spirit and scope of the following claims.

What is claimed is:

1. A method of allocating communications traffic in a wireless communications system, the method comprising the steps of:
providing a plurality of communication channels, each having a unique first parameter associated therewith;
providing a plurality of second parameters, each associated with a specific traffic function;
providing a first traffic element;
associating a first parameter and a second parameter with the first traffic element; and
allocating the first traffic element access to a first communication channel, associated with the first traffic element's first parameter, based upon the first traffic element's first and second associated parameters.

2. The method of claim 1, wherein the wireless communications system is an Evolution Data-Only (EVDO) based system.

3. The method of claim 2, wherein the wireless communications system is an Enhanced Evolution Data-Only (EEVDO) based system.

4. The method of claim 1, further comprising:
providing a second traffic element;
associating a first parameter and a second parameter with the second traffic element; and
allocating the second traffic element access to the first communication channel concurrent with the first traffic element, where the second traffic element's first associated parameter is the same as the first traffic element's first associated parameter, and the second traffic element's second associated parameter is different from the first traffic element's second associated parameter.

5. The method of claim 1, wherein the plurality of first parameters comprises a first plurality of Walsh codes.

6. The method of claim 1, wherein the plurality of second parameters comprises a second plurality of Walsh codes.

7. The method of claim 1, wherein the first traffic element's second associated parameter indicates forward channel communication.

8. The method of claim 1, wherein the first traffic element's second associated parameter indicates reverse channel communication.

9. The method of claim 1, wherein the first traffic element's second associated parameter indicates control communication.

10. The method of claim 1, wherein the first traffic element's second associated parameter indicates user data communication.

11. The method of claim 1, further comprising:
providing a traffic allocation message;
providing a prioritization element of the traffic allocation message to prioritize allocation to the plurality of communication channels based upon a traffic element's second parameter; and
allocating the first traffic element access to the first communication channel subject to the prioritization element.

12. The method of claim 11, wherein the prioritization element prioritizes control traffic.

13. The method of claim 11, wherein the prioritization element prioritizes control traffic.

14. A method of providing shared utilization of a single traffic channel in an Evolution Data-Only (EVDO) based system, the method comprising the steps of:
providing a communication channel, having a unique first parameter associated therewith;
providing a plurality of second parameters, each associated with a specific traffic function;
providing a first traffic element and a second traffic element;
associating the unique first parameter, and one of the plurality of second parameters, with the first traffic element;
associating the unique first parameter, and one of the plurality of second parameters, with the second traffic element;
allocating the first traffic element access to the communication channel; and
allocating the second traffic element access to the communication channel concurrent with the first traffic element, where the one of the plurality of second parameters associated with the second traffic element is different from the one of the plurality of second parameters associated with the first traffic element.

15. The method of claim 14, wherein the Evolution Data-Only (EVDO) based system is an Enhanced Evolution Data-Only (EEVDO) based system.

16. The method of claim 14 wherein the unique first parameters comprises a Walsh code.

17. The method of claim 14, wherein the plurality of second parameters comprises a plurality of Walsh codes.

18. The method of claim 14, wherein the one of the plurality of second parameters associated with the first traffic element indicates forward channel communication.

19. The method of claim 14, wherein the one of the plurality of second parameters associated with the first traffic element indicates control communication.

20. The method of claim 14, wherein the one of the plurality of second parameters associated with the first traffic element indicates user data communication.

21. A wireless communication system comprising:
a communication channel, having a unique first parameter associated therewith, and having a plurality of specific traffic functions each having a unique second parameter associated therewith;
a first traffic element for transmission over the communication channel; and
a second traffic element for transmission over the communication channel;
wherein the unique first parameter and a unique second parameter are associated with the first traffic element, and the unique first parameter and a unique second parameter are associated with the second traffic element, and the first traffic element is allocated access to the communication channel, and the second traffic element is allocated access to the communication channel concurrent with the first traffic element where the unique second parameter are associated with the second traffic element is different from unique second parameter are associated with the first traffic element.

22. The system of claim 21, wherein the Evolution Data-Only (EVDO) based system is an Enhanced Evolution Data-Only (EEVDO) based system.

23. The system of claim 21, wherein the unique second parameter associated with the first traffic element indicates forward channel communication.

24. The system of claim 21, wherein the unique second parameter associated with the first traffic element indicates control communication.

25. The system of claim 21, wherein the unique second parameter associated with the first traffic element indicates user data communication.

26. A wireless communication device comprising:
access to a plurality of communication channels, each having a unique first parameter associated therewith;
a plurality of second parameters, each associated with a specific traffic function; and
a traffic element to be transmitted over one of the plurality of communication channels;
wherein a first parameter and a second parameter is associated with the traffic element, and the wireless communication device is allocated access to a first communication channel, associated with the traffic element's first parameter, based upon the traffic element's first and second associated parameters.

27. The device of claim 26, wherein the Evolution Data-Only (EVDO) based system is an Evolution Data-Only (EVDO) based system.

28. The device of claim 26, wherein the Evolution Data-Only (EVDO) based system is an Enhanced Evolution Data-Only (EEVDO) based system.
